(19) United States
(12) Patent Application Publication
(10) Pub. No.: US 2014/0028460 A1
(43) Pub. Date: Jan. 30, 2014

(54) EARTHQUAKE WARNING SYSTEM AND METHOD FOR PROVIDING EARTHQUAKE WARNING TO BE USED IN CONNECTION WITH EARTHQUAKE WARNING SYSTEM

(71) Applicant: NATIONAL TAIPEI UNIVERSITY OF TECHNOLOGY, Taipei City (TW)

(72) Inventors: To-Po Wang, Taipei City (TW); Tzung-Ching Lin, Taipei City (TW); Shih-Hua Chiang, Taipei City (TW); Yih-Min Wu, Taipei City (TW)

(73) Assignee: National Taipei University of Technology

(21) Appl. No.: 13/770,472

(22) Filed: Feb. 19, 2013

(30) Foreign Application Priority Data
Jul. 25, 2012 (TW) 101126799

(51) Int. Cl. G08B 21/18

(52) U.S. Cl. CPC G08B 21/182
USPC 340/669

(57) ABSTRACT

An earthquake warning system includes an acceleration detection unit, a controller unit and an alarming unit. The acceleration detection unit is for detecting a plurality of earthquake accelerations respectively with respect to a plurality of axes, and generates a plurality of detecting signals. The controller unit is electrically connected to the acceleration detection unit for receiving the detecting signals therefrom, and generates a detection value. The alarming unit is operable under a plurality of alarming modes which respectively correspond to the seismic scales and in each of which an alarm having a distinct alarming level that corresponds to the corresponding one of the seismic scales is produced.

### CROSS-REFERENCE TO RELATED APPLICATION

This application claims priority of Taiwanese Patent Application No. 101126799, filed on Jul. 25, 2012.

### BACKGROUND OF THE INVENTION

1. Field of the Invention

This invention relates to an earthquake warning system and a method for providing earthquake warning to be used in connection with an earthquake warning system.

2. Description of the Related Art

A conventional earthquake warning system utilizes a pendulum to determine a seismic scale of an earthquake in a relatively inaccurate way by measuring a swing angle of the pendulum.

Another conventional earthquake warning system involves an accelerometer, and releases an earthquake warning alarm when an acceleration detected by the accelerometer is greater than a predetermined threshold, but fails to indicate a seismic scale. In addition, the earthquake warning alarm is a buzzing sound, which is unpleasant to the ear.

### SUMMARY OF THE INVENTION

Therefore, an object of the present invention is to provide an earthquake warning system that is capable of overcoming the aforesaid drawbacks associated with the prior art.

Accordingly, an earthquake warning system of this invention includes an acceleration detecting unit, a controller unit and an alarming unit.

The acceleration detection unit detects a plurality of earthquake accelerations respectively with respect to a plurality of axes, and generates a plurality of detecting signals respectively with reference to the earthquake accelerations.

The controller unit is electrically connected to the acceleration detection unit for receiving the detecting signals therefrom, generates a detection value with reference to the detecting signals, and compares the detection value to a plurality of predetermined thresholds, which are respectively associated with a plurality of seismic scales. The controller unit outputs, when the detection value is determined to exceed at least one of the predetermined thresholds, a drive signal that corresponds to one of the seismic scales with which the greatest of said at least one of the predetermined thresholds is associated.

The alarming unit is operable under a plurality of alarming modes, which respectively correspond to the seismic scales and in each of which an alarm having a distinct alarming level that corresponds to the corresponding one of the seismic scales is produced. The alarming unit is electrically connected to the controller unit to be driven by the drive signal to operate under one of the alarming modes corresponding to said one of the seismic scales to which the drive signal corresponds.

Another object of the present invention is to provide a method for providing earthquake warning to be used in connection with an earthquake warning system. Accordingly, the present invention further provides a method for providing earthquake warning to be used in connection with an earthquake warning system that includes a controller unit and an alarming unit. The method comprises the steps of:

(A) configuring the controller unit to generate a detection value with reference to a plurality of detecting signals that respectively correspond to a plurality of earthquake accelerations measured with respect to a plurality of axes;

(B) configuring the controller unit to compare the detection value to a plurality of predetermined thresholds, which are respectively associated with a plurality of seismic scales; and

(C) configuring the controller unit to, when the detection value is determined to exceed at least one of the predetermined thresholds, control the alarming unit to operate under one of a plurality of alarming modes that correspond to one of the seismic scales with which the greatest of said at least one of the predetermined thresholds is associated, wherein the alarming modes respectively correspond to the seismic scales, and the alarming unit, when operating under each of the alarming modes, produces an alarm having a distinct alarming level that corresponds to the corresponding one of the seismic scales.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a block diagram of an earthquake warning system according to the preferred embodiment of this invention;

FIG. 2 is a circuit diagram of a power converter module of the earthquake warning system according to the preferred embodiment;

FIG. 3 is a circuit diagram of an acceleration detection unit of the earthquake warning system according to the preferred embodiment; and

FIGS. 4 to 6 are flow charts illustrating a method for providing earthquake warning to be used in connection with an earthquake warning system according to the preferred embodiment of this invention.

### DETAILED DESCRIPTION OF THE PREFERRED EMBODIMENT

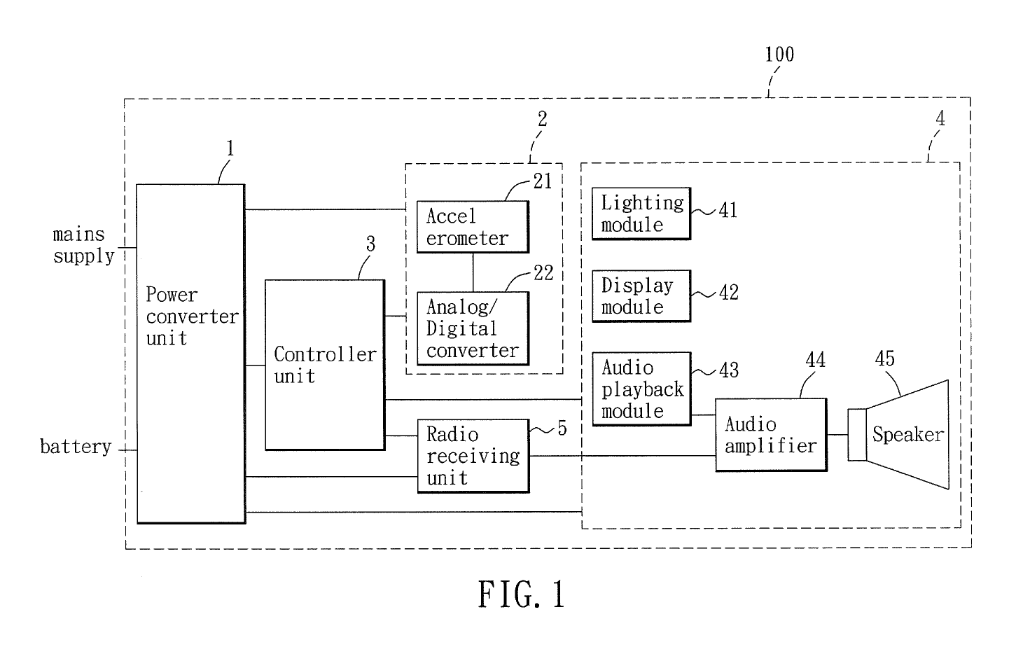

FIG. 1 is a block diagram of an earthquake warning system 100 according to the preferred embodiment of this invention. The earthquake warning system 100 includes a power converter unit 1, an acceleration detection unit 2, a controller unit 3, an alarming unit 4, and a radio receiving unit 5.

The power converter unit 1 is electrically connected to the acceleration detection unit 2, the controller unit 3, the alarming unit 4 and the radio receiving unit 5. The power converter unit 1 is electrically connectable to a mains supply for receiving mains electricity therefrom, and is further electrically connectable to a power storage unit, e.g., a battery. When the power converter unit 1 is electrically connected to both of the mains supply and the power storage unit, the power converter unit 1 uses the mains electricity to charge the power storage unit and to drive operations of the acceleration detection unit 2, the controller unit 3, the alarming unit 4 and the radio receiving unit 5. When the power converter unit 1 is electrically connected to the mains supply and not to the power storage unit, the power converter unit 1 uses the mains electricity for driving the operations of the acceleration detection unit 2, the controller unit 3, the alarming unit 4 and the radio receiving unit 5. When the power converter unit 1 is electrically connected to the power storage unit and not to the mains supply, the power converter unit 1 uses power stored in the power storage unit for driving the operations of the acceleration detection unit 2, the controller unit 3, the alarming unit 4 and the radio receiving unit 5.

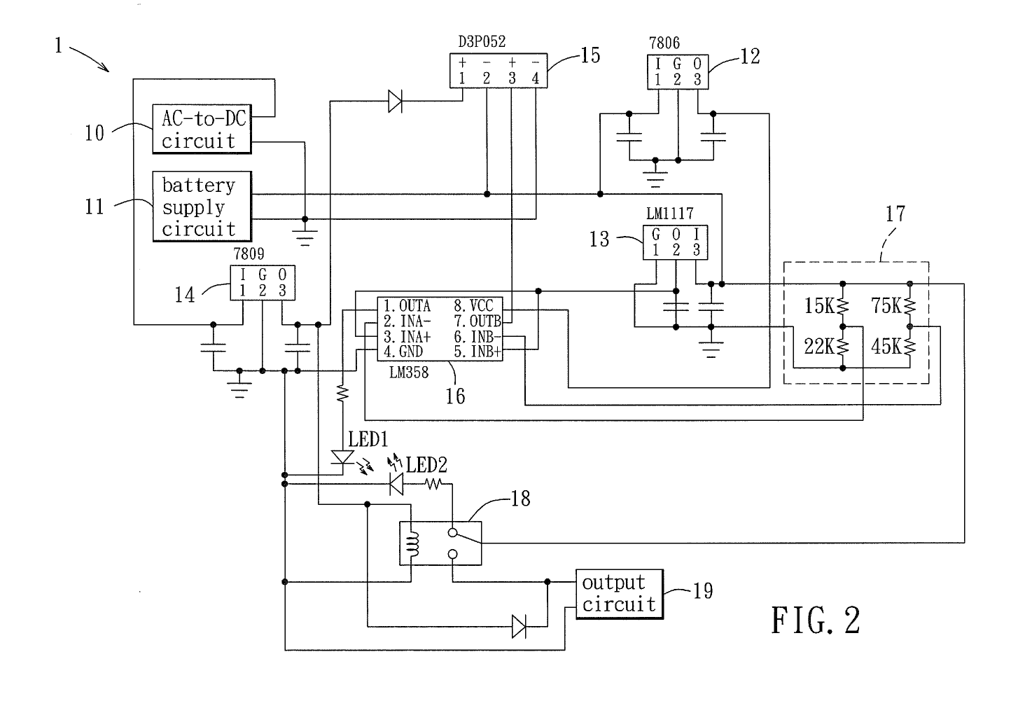

Referring to FIG. 2, the power converter unit 1 includes an AC-to-DC circuit 10, a battery circuit 11, three voltage regulators 12, 13, 14, a D3P052 DC solid state relay 15, a comparing circuit 16, a voltage divider 17, a switch circuit 18, and an output circuit 19.

In this embodiment, the AC-to-DC circuit 10 is connectable to the mains supply for receiving the mains electricity therefrom, and converts the 110V AC mains electricity to 12V DC power. The battery circuit 11 is connectable to the power storage unit, which is a 9V battery in this embodiment, and draws the power from the battery. The voltage regulator 12 adopts a 6V regulator integrated circuit (IC), such as the 7806 voltage regulator IC, is electrically connected to the AC-to-DC circuit 10 through the 9V voltage regular 14 and the D3P052 DC solid state relay 15 for generating a 6V DC voltage from the 12V DC power, and is further electrically connected to the comparing circuit 16 for providing the 6V DC voltage thereto to serve as an operating voltage (VCC) of the comparing circuit 16. The voltage regulator 13 adopts a 3.3V regulator IC, such as the LM1117 voltage regulator IC, is electrically connected to the AC-to-DC circuit 10 for generating a 3.3V DC voltage from the 12V DC power, and is further electrically connected to the comparing circuit 16 through the 9V voltage regular 14 and the D3P052 DC solid state relay 15 for providing the 3.3V DC voltage thereto to serve as reference voltages (INA+, INB+) of the comparing circuit 16. The voltage regulator 14 is a 9V regulator IC, such as the 7809 voltage regulator IC, is electrically connected to the AC-to-DC circuit 10 for generating a 9V DC voltage from the 12V DC power, and is further electrically connected to the D3P052 DC solid state relay 15 for providing the 9V DC voltage thereto. The D3P052 DC solid state relay 15 is electrically connected to the voltage regulator 14 and the battery circuit 11 for controlling whether to charge the power storage unit when the same is connected electrically to the battery circuit 11. The comparing circuit 16 is a comparator, such as the LM358 comparator, for determining whether the power storage unit is fully charged. The switch circuit 18 is a relay, such as the LEG-9 relay, and is connected electrically to the voltage regulator 14, the battery circuit 11 and the output circuit 19. The output circuit 19 is electrically connected to the acceleration detection unit 2, the controller unit 3, the alarming unit 4 and the radio receiving unit 5. The switch circuit 18 selects whether the mains electricity from the mains supply that is connected electrically to the AC-to-DC circuit 10 or the power from the power storage unit that is connected electrically to the battery circuit 11 is to be used for output via the output circuit 19 in order to drive operations of the acceleration detection unit 2, the controller unit 3, the alarming unit 4 and the radio receiving unit 5.

Operation of the comparing circuit 16 will now be described. When the power storage unit is under charged by the 9V DC voltage from the voltage regulator 14, an internal voltage of the power storage unit, i.e., the power stored in the power storage unit, undergoes voltage division by two branches (15KΩ, 22KΩ and 75KΩ, 45 KΩ) of the voltage divider 17, and the resultant voltages are transmitted back to the comparing circuit 16 to serve as reference voltages (INA−, INB−). When the internal voltage of the power storage unit exceeds 8.8V, the reference voltage (INB−) of the comparing circuit 16 will exceed 3.3V, and the comparing circuit 16 will output a signal via an output pin (OUTS) to control the D3P052 DC solid state relay 15 to stop the charging of the power storage unit.

When the internal voltage of the power storage unit is lower than 5.5V, the reference voltages (INA−) of the comparing circuit 16 will be lower than 3.2V, and the comparing circuit 16 will output a signal via another output pin (OUTA) to drive a light emitting diode (LED1) to illuminate so as to indicate that the power storage unit is low in power.

When the power converter unit 1 is electrically connected to both the mains supply and the power storage unit, a relay of the switch circuit 18 switches to a light emitting diode (LED2) so that the same is electrically connected between ground and the battery circuit 11 for receiving the power from the power storage unit, causing the light emitting diode (LED2) to illuminate. When the power converter unit 1 is connected to the power storage unit, but not connected to the mains supply, the relay of the switch circuit 18 is disconnected from the light emitting diode (LED2), such that the same is not driven to illuminate, and the power from the power storage unit is eventually provided to the output circuit 19.

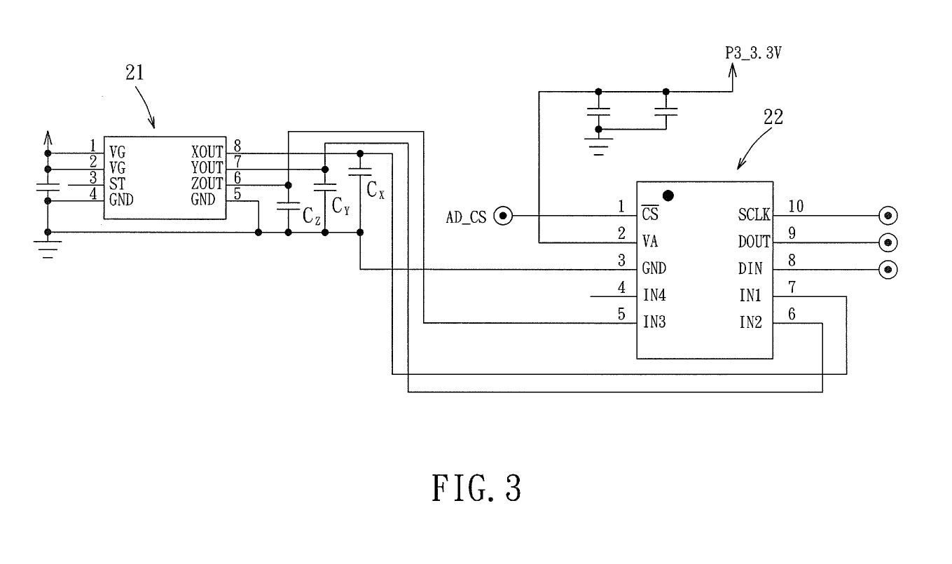

Referring to FIGS. 1 and 3, the acceleration detection unit 2 is for detecting a plurality of earthquake accelerations respectively with respect to a plurality of axes, and generates a plurality of detecting signals respectively with reference to the earthquake accelerations. The acceleration detection unit 2 includes an accelerometer 21 and an analog/digital (A/D) converter 22.

The accelerometer 21 is for detecting the earthquake accelerations respectively with respect to the axes so as to generate a plurality of acceleration signals. The analog/digital (A/D) converter 22 is electrically connected to the accelerometer 21 for receiving the acceleration signals therefrom, and performs A/D conversion on each of the acceleration signals so as to generate a corresponding one of the detecting signals. In this embodiment, the plurality of axes includes three axes (X), (Y) and (Z) that are perpendicular to one another.

Referring back to FIG. 1, the controller unit 3 is electrically connected to the acceleration detection unit 2 for receiving the detecting signals therefrom, generates a detection value (D) with reference to the detecting signals, and compares the detection value (D) to a plurality of predetermined thresholds, which are respectively associated with a plurality of seismic scales. The controller unit 3 outputs, when the detection value (D) is determined to exceed at least one of the predetermined thresholds, a drive signal, that corresponds to one of the seismic scales with which the greatest of said at least one of the predetermined thresholds is associated, to the alarming unit 4. For simplicity of illustration, in this embodiment, there are three predetermined thresholds, respectively set to be 8 gal, indicating a weak earthquake, 25 gal, indicating a medium earthquake, and 80 gal indicating a strong earthquake. Note that gal is a unit of acceleration defined as cm/s².

It should be noted herein that the predetermined thresholds are not to be limited to those disclosed herein, and may also be set to correspond to seismic intensity scale standards used in different parts of the world.

The controller unit 3 generates the detection value (D) by, for each of the axes, taking an average of a predetermined number of inputs of the corresponding one of the detecting signals received from the acceleration detection unit 2, subtracting a corresponding predetermined base value from the average to obtain a variation value, and by taking a square root of a sum of squares of the variation values respectively corresponding to the axes. The predetermined base value corresponding to each of the axes is obtained by the controller unit 3 through taking an average of an initial set of the predetermined number of inputs of the corresponding one of the detecting signals received from the acceleration detection unit 2.

The alarming unit 4 is operable under a plurality of alarming modes, which respectively correspond to the seismic scales and in each of which an alarm having a distinct alarming level that corresponds to the corresponding one of the seismic scales is produced. The alarming unit 4 is electrically connected to the controller unit 3 to be driven by the drive signal to operate under one of the alarming modes corresponding to said one of the seismic scales to which the drive signal corresponds.

The alarming unit 4 includes a lighting module 41, a display module 42, an audio playback module 43, an audio amplifier 44 and a speaker 45.

The light module 41 is driven by the drive signal to produce the alarm in the form of light with a luminance intensity that corresponds to said one of the seismic scales to which the drive signal corresponds.

The display module 42 is driven by the drive signal to produce the alarm in the form of a display indicating said one of the seismic scales to which the drive signal corresponds.

The audio playback module 43 is driven by the drive signal to produce the alarm in the form of an audio recording, with a sound volume that corresponds to said one of the seismic scales to which the drive signal corresponds, by selecting from a plurality of pre-recorded audio recordings each of which corresponds to said one of the seismic scales to which the drive signal corresponds. The audio recording is played through the audio amplifier 44 and the speaker 45, which are connected electrically in series with the audio playback module 43. The radio receiving unit 5 is electrically connected to the controller unit 3. The controller unit 3 further outputs a control signal to the radio receiving unit 5 upon reaching a predetermined period of time after the drive signal is outputted to the alarming unit 4 so as to control the radio receiving unit 5 to receive and playback radio broadcasting signals. The radio receiving unit 5 is also electrically connected in series to the audio amplifier 44 and the speaker 45 for playing the radio broadcasting signals there through.

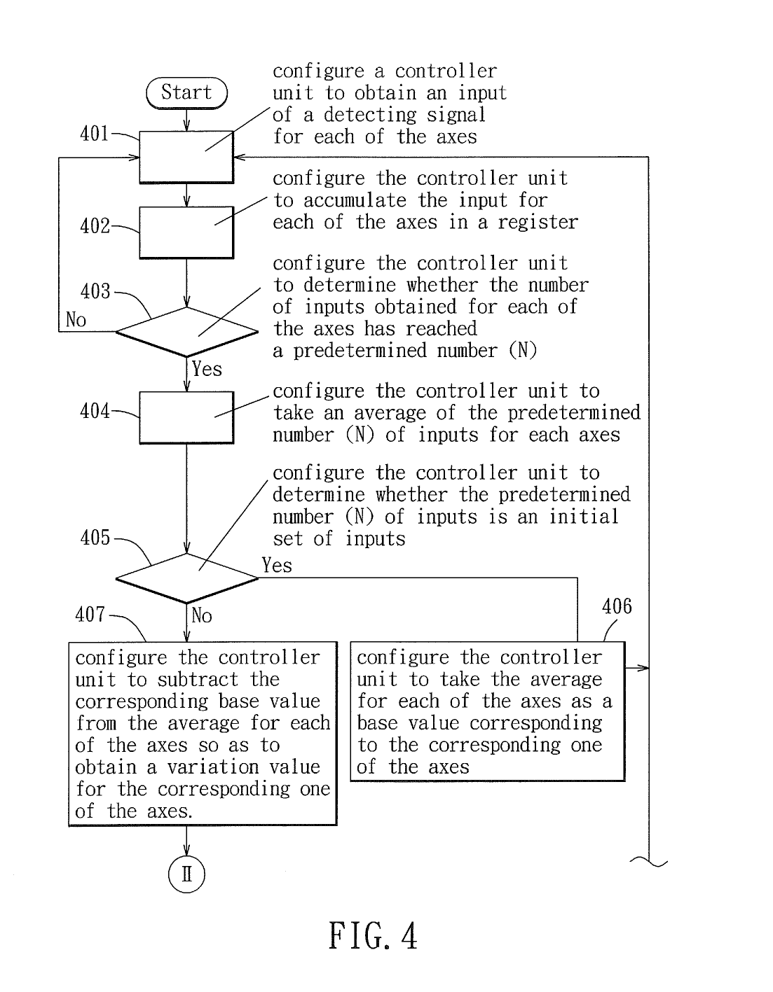

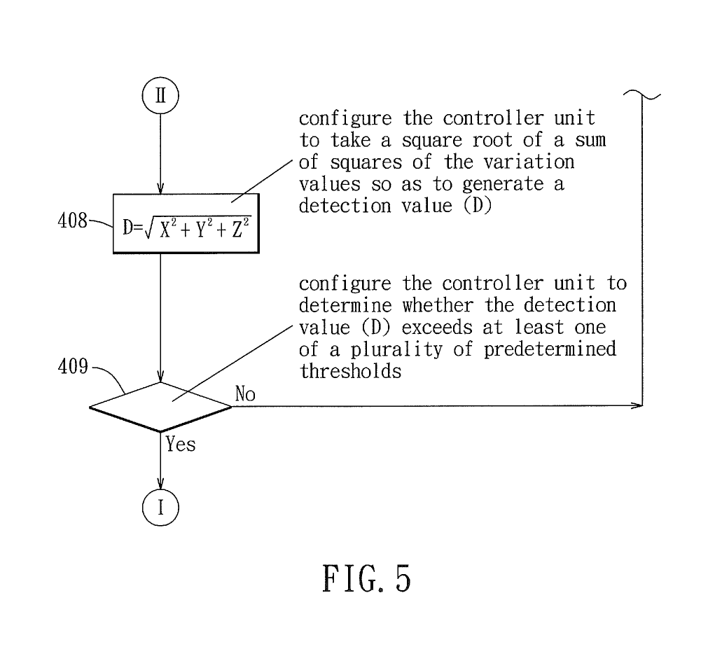

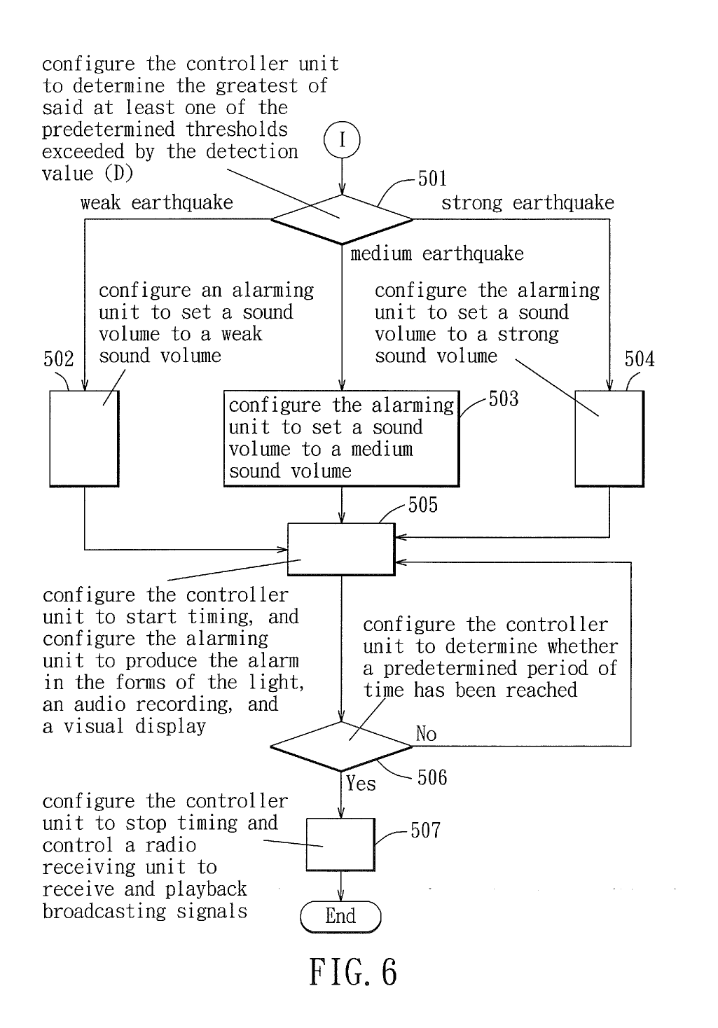

FIGS. 4 to 6 illustrate a method for providing earthquake warning to be used in connection with an earthquake warning system, such as the one discussed above, according to the preferred embodiment of this invention. The method may be divided into two procedures, namely an initial procedure (steps 401˜409 in FIGS. 4 and 5) and an alarm control procedure (steps 501˜507 in FIG. 6).

Referring to FIGS. 4 and 5, in step 401, a controller unit 3 is configured to obtain an input of a detecting signal for each of the axes, where the detecting signal corresponds to an earthquake acceleration that is measured with respect to a corresponding one of the axes, for example by an acceleration detection unit 2 shown in FIG. 1. Next, in step 402, the input for each of the axes is cumulated, for example, in a register of the controller unit 3. Subsequently, in step 403, the controller unit 3 is configured to determine whether the number of inputs obtained for each of the axes has reached a predetermined number (N). In the negative, the flow goes to step 401, and if affirmative, the flow proceeds to step 404. In step 404, the controller unit 3 is configured to take an average of the predetermined number (N) of inputs for each of the axes. After step 404, the flow goes to step 405, where the controller unit 3 is configured to determine whether the predetermined number (N) of inputs is an initial set of inputs, i.e., whether the initial procedure is executed for the first time. If affirmative, the flow goes to step 406, and in the negative, the flow goes to step 407. In step 406, the controller unit 3 is configured to take the average for each of the axes as a base value corresponding to the corresponding one of the axes, and the base value is, for example, stored in the register. The flow goes back to step 401 after step 406. In step 407, the controller unit 3 is configured to subtract the corresponding base value from the average for each of the axes so as to obtain a variation value for the corresponding one of the axes. After step 407, the flow goes to step 408, where the controller unit 3 is configured to take a square root of a sum of squares of the variation values respectively corresponding to the axes so as to generate a detection value (D). Subsequently, in step 409, the controller unit 3 is configured to compare the detection value (D) with a plurality of predetermined thresholds, which are respectively associated with a plurality of seismic scales, and determine whether the detection value (D) exceeds at least one of the predetermined thresholds. In the negative, the flow goes back to step 401, and if affirmative, the flow proceeds to the alarm control procedure as follows.

Referring to FIG. 6, in step 501, the controller unit 3 is configured to determine the greatest of said at least one of the predetermined thresholds exceeded by the detection value (D), and based on this determination, the controller unit 3 is configured to control an alarming unit 4 (as shown in FIG. 1) to operate under one of a plurality of alarming modes that corresponds to one of the seismic scales with which the greatest of said at least one of the predetermined thresholds is associated. When operating under each of the alarming modes, the alarming unit 4 is configured to produce an alarm having a distinct alarming level that corresponds to the corresponding one of the seismic scales. In each alarming mode, the alarming unit 4 is configured to produce the alarm in the forms of an audio recording, light and a visual display. The audio recording has a sound volume that corresponds to the corresponding seismic scale. The light has a luminance intensity that corresponds to the corresponding seismic scale. The visual display indicates the corresponding seismic scale. Alternatively or additionally, the audio recording may be selected from a plurality of pre-recorded audio recordings that respectively correspond to the seismic scales, i.e., there is a distinct audio recording for each seismic scale.

For simplicity of illustration, in this embodiment, there are three predetermined thresholds respectively corresponding to a low seismic scale (weak earthquake), a medium seismic scale (medium earthquake), and a high seismic scale (strong earthquake), and accordingly, there are three alarming modes, namely a weak earthquake mode, a medium earthquake mode and a strong earthquake mode that are respectively associated with the three predetermined thresholds, and that respectively correspond to the low, medium and high seismic scales. Therefore, the flow may go to one of three paths, i.e., steps 502, 503 and 504, after step 501. If it is determined in step 501 that the greatest of said at least one of the predetermined thresholds is one that corresponds to the weak earthquake, the controller unit 3 controls the alarming unit 4 to operate under the weak earthquake mode, and the flow goes to step 502. If it is determined in step 501 that the greatest of said at least one of the predetermined thresholds is one that corresponds to the medium earthquake, the controller unit 3 controls the alarming unit 4 to operate under the medium earthquake mode, and the flow goes to step 503. If it is determined in step 501 that the greatest of said at least one of the predetermined thresholds is one that corresponds to the strong earthquake, the controller unit 3 controls the alarming unit 4 to operate under the strong earthquake mode, and the flow goes to step 504.

In step 502, the alarming unit 4 is configured to set a sound volume to a low sound volume. In step 503, the alarming unit 4 is configured to set a sound volume to a medium sound volume. In step 504, the alarming unit 4 is configured to set a sound volume to a strong sound volume. After completion of each of steps 502, 503 and 504, the flow goes to step 505.

In step 505, the controller unit 3 is configured to start timing, and the alarming unit 4 is configured to produce the alarm in the form of the light with a luminance intensity that corresponds to said one of the seismic scales with which the greatest of said at least one of the predetermined thresholds is associated, to further produce the alarm in the form of the audio recording with the sound volume previously set in step 502 or 503 or 504 and with a content that corresponds to said one of the seismic scales with which the greatest of said at least one of the predetermined thresholds is associated, and to further produce the alarm in the form of the visual display that indicates said one of the seismic scales with which the greatest of said at least one of the predetermined thresholds is associated. The audio recording is one that has a content corresponding to said one of the seismic scales with which the greatest of said at least one of the predetermined thresholds is associated and that is selected from a plurality of pre-recorded audio recordings respectively corresponding to the seismic scales.

Subsequently, in step 506, the controller unit 3 is configured to determine whether a predetermined period of time has been reached. If affirmative, the flow goes to step 507, and in the negative, the flow goes back to step 505.

In step 507, the controller unit 3 is configured to stop timing, and to control a radio receiving unit 5 to receive and playback broadcasting signals.

The effects of this invention reside in that the provision of multiple alarming modes allows the alarming unit 4 to produce an alarm that notifies people of the seismic scale measured for the current earthquake, that the use of different forms of alarms provides not only warning, but also assistance for guiding the people to perform corresponding safety measures, such as to escape, that the use of the radio receiving unit 5 allows automatic playback of potentially relevant information, for instance, news, and that the adoptability to multiple power sources permits the option of using a power storage unit, such as a battery, to drive operation of the earthquake warning system so that the same may function during power outage.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

What is claimed is:

1. An earthquake warning system, comprising:
an acceleration detection unit for detecting a plurality of earthquake accelerations respectively with respect to a plurality of axes, and generating a plurality of detecting signals respectively with reference to the earthquake accelerations;
a controller unit electrically connected to said acceleration detection unit for receiving the detecting signals therefrom, generating a detection value with reference to the detecting signals, and comparing the detection value to a plurality of predetermined thresholds, which are respectively associated with a plurality of seismic scales, said controller unit outputting, when the detection value is determined to exceed at least one of the predetermined thresholds, a drive signal that corresponds to one of the seismic scales with which the greatest of said at least one of the predetermined thresholds is associated; and
an alarming unit operable under a plurality of alarming modes, which respectively correspond to the seismic scales and in each of which an alarm having a distinct alarming level that corresponds to the corresponding one of the seismic scales is produced, said alarming unit being electrically connected to said controller unit to be driven by the drive signal to operate under one of the alarming modes corresponding to said one of the seismic scales to which the drive signal corresponds.

2. The earthquake warning system of claim 1, wherein said controller unit generates the detection value by, for each of the axes, taking an average of a predetermined number of inputs of the corresponding one of the detecting signals received from said acceleration detection unit, subtracting a corresponding predetermined base value from the average to obtain a variation value, and by taking a square root of a sum of squares of the variation values respectively corresponding to the axes.

3. The earthquake warning system of claim 2, wherein the predetermined base value corresponding to each of the axes is obtained by said controller unit through taking an average of an initial set of the predetermined number of inputs of the corresponding one of the detecting signals received from said acceleration detection unit.

4. The earthquake warning system of claim 1, further comprising:
a power converter unit electrically connected to said acceleration detection unit, said controller unit and said alarming unit, electrically connectable to a mains supply for receiving mains electricity therefrom, and further electrically connectable to a power storage unit;
wherein when said power converter unit is electrically connected to both of the mains supply and the power storage unit, said power converter unit uses the mains electricity to charge the power storage unit and to drive operations of said acceleration detection unit, said controller unit and said alarming unit;
wherein when said power converter unit is electrically connected to the mains supply and not to the power storage unit, said power converter unit uses the mains electricity for driving the operations of said acceleration detection unit, said controller unit and said alarming unit; and
wherein when said power converter unit is electrically connected to the power storage unit and not to the mains supply, said power converter unit uses power stored in the power storage unit for driving the operations of said acceleration detection unit, said controller unit and said alarming unit.

5. The earthquake warning system of claim 1, wherein said alarming unit includes a lighting module driven by the drive signal to produce the alarm in the form of light with a luminance intensity that corresponds to said one of the seismic scales to which the drive signal corresponds.

6. The earthquake warning system of claim 1, wherein said alarming unit includes a display module driven by the drive signal to produce the alarm in the form of a visual display indicating said one of the seismic scales to which the drive signal corresponds.

7. The earthquake warning system of claim 1, wherein said alarming unit includes an audio playback module driven by the drive signal to produce the alarm in the form of an audio recording with a sound volume that corresponds to said one of the seismic scales to which the drive signal corresponds.

8. The earthquake warning system of claim 1, wherein said alarming unit includes an audio playback module driven by the drive signal to produce the alarm in the form of an audio recording by selecting from a plurality of pre-recorded audio recordings that respectively correspond to the seismic scales, one of the audio recordings that corresponds to said one of the seismic scales to which the drive signal corresponds.

9. The earthquake warning system of claim 1, further comprising a radio receiving unit electrically connected to said controller unit, said controller unit further outputting a control signal to said radio receiving unit upon reaching a predetermined period of time after the drive signal is outputted so as to control said radio receiving unit to receive and playback radio broadcasting signals.

10. The earthquake warning system of claim 1, wherein said acceleration detection unit includes:
an accelerometer for detecting the earthquake accelerations respectively with respect to the axes so as to generate a plurality of acceleration signals; and
an analog/digital (A/D) converter electrically connected to said accelerometer for receiving the acceleration signals therefrom, and performing A/D conversion on each of the acceleration signals so as to generate a corresponding one of the detecting signals.

11. The earthquake warning system of claim 1, wherein the plurality of axes include three axes that are perpendicular to one another.

12. A method for providing earthquake warning to be used in connection with an earthquake warning system, the earthquake warning system including a controller unit and an alarming unit, the method comprising the steps of:
(A) configuring the controller unit to generate a detection value with reference to a plurality of detecting signals that respectively correspond to a plurality of earthquake accelerations measured with respect to a plurality of axes;
(B) configuring the controller unit to compare the detection value to a plurality of predetermined thresholds, which are respectively associated with a plurality of seismic scales; and
(C) configuring the controller unit to, when the detection value is determined to exceed at least one of the predetermined thresholds, control the alarming unit to operate under one of a plurality of alarming modes that corresponds to one of the seismic scales with which the greatest of said at least one of the predetermined thresholds is associated, wherein the alarming modes respectively correspond to the seismic scales, and the alarming unit, when operating under each of the alarming modes, produces an alarm having a distinct alarming level that corresponds to the corresponding one of the seismic scales.

13. The method of claim 12, wherein step (A) includes the sub-steps of:
(A-1) configuring the controller unit to, for each of the axes, take an average of a predetermined number of inputs of the corresponding one of the detecting signals, and subtract a corresponding predetermined base value from the average so as to obtain a variation value; and
(A-2) configuring the controller unit to take a square root of a sum of squares of the variation values respectively corresponding to the axes so as to generate the detection value.

14. The method of claim 13, wherein step (A) further includes the sub-step of:
(A-3) configuring the controller unit to, for each of the axes, take an average of an initial set of the predetermined number of inputs of the corresponding one of the detecting signals to obtain the corresponding predetermined base value.

15. The method of claim 12, wherein in step (C), the alarming unit is configured to produce the alarm in the form of an audio recording with a sound volume that corresponds to said one of the seismic scales with which the greatest of said at least one of the predetermined thresholds is associated.

16. The method of claim 12, wherein in step (C), the alarming unit is configured to produce the alarm in the form of light with a luminance intensity that corresponds to said one of the seismic scales with which the greatest of said at least one of the predetermined thresholds is associated.

17. The method of claim 12, wherein in step (C), the alarming unit is configured to produce the alarm in the form of a visual display that indicates said one of the seismic scales with which the greatest of said at least one of the predetermined thresholds is associated.

18. The method of claim 12, wherein in step (C), the alarming unit is configured to produce the alarm in the form of an audio recording by selecting from a plurality of pre-recorded audio recordings that respectively correspond to the seismic scales, one of the audio recordings that corresponds to said one of the seismic scales.

19. The method of claim 12, the earthquake warning system further including a radio receiving unit, the method further comprising the step of:
(D) configuring the controller unit to control the radio receiving unit to receive and playback broadcasting signals upon reaching a predetermined period of time after the controller unit controls the alarming unit to operate under said one of the alarming modes.

20. The method of claim 12, wherein the plurality of axes includes three axes that are perpendicular to one another.
